(19) United States
(12) Patent Application Publication
(10) Pub. No.: US 2018/0023731 A1
(43) Pub. Date: Jan. 25, 2018

(54) MULTI-LAYERED COILED TUBING DESIGNS WITH INTEGRATED ELECTRICAL AND FIBER OPTIC COMPONENTS

(71) Applicant: Schlumberger Technology Corporation, Sugar Land, TX (US)

(72) Inventors: Joseph Varkey, Sugar Land, TX (US); Douglas Pipchuk, Calgary (CA)

(21) Appl. No.: 15/213,850

(22) Filed: Jul. 19, 2016

(51) Int. Cl. F16L 11/20; F16L 55/00; H01B 11/22; G01D 5/26

(52) U.S. Cl. CPC F16L 11/20; G01D 5/268; F16L 55/00; H01B 11/22

(57) ABSTRACT

A multi-layer coiled tube is provided. The multi-layer coiled tube may include an inner coiled tube. An outer tube may circumferentially and longitudinally surround the inner coiled tube. Conductors may be positioned between the inner coiled tube and the outer tube. The conductors may include electrical conductors and fiber optic cables.

### CROSS-REFERENCE TO RELATED APPLICATIONS

Not applicable.

### FIELD

Embodiments of the present disclosure generally relate to coiled tubing having electrical and fiber optic components.

### BACKGROUND

Coiled tubing operations traditionally require electrical conductors to power activities such as drilling, milling, and removal of sand and debris. Fiber optic components are used increasingly in coiled tubing operations to monitor downhole conditions during operations such as fracturing. One traditional approach to deploying electrical and fiber optic components in coiled tubing operations includes deploying cable containing the electrical and fiber optic components loosely within a central channel of the coiled tube, which presents several problems and limitations. Loose components within the central channel of the coiled tube restrict the flow of fluid down the coiled tube. Additionally, over time, frictional forces on the cable from pumped fluids, e.g. mud, stretches the cable, causing slack cable to accumulate at the bottom of the coiled tube. Management of the accumulation of such slack cable has traditionally been accomplished by reversing the flow of the fluid within the coiled tube to redistribute the cable to its original location, a time-consuming and unscientific process. Also, when pumping high viscosity materials with loose cable deployed within the central channel of the coiled tube, pumping speeds are traditionally slowed to prevent breaking the cable.

### SUMMARY

The present disclosure provides for a multi-layer coiled tube. The multi-layer coiled tube may include an inner coiled tube. An outer tube may circumferentially and longitudinally surround the inner coiled tube. Conductors may be positioned between the inner coiled tube and the outer tube. The conductors may include electrical conductors and fiber optic cables.

The present disclosure provides for a system. The system may include a tubing reel located at a surface. The system may include a multi-layer coiled tube. The multi-layer coiled tube may include an inner coiled tube, an outer tube circumferentially and longitudinally surrounding the inner coiled tube, and conductors positioned between the inner coiled tube and the outer tube. The conductors may include electrical conductors and fiber optic cables. The multi-layer coiled tube may be wrapped about the tubing reel at a first end of the multi-layer coiled tube. A second end of the multi-layer coiled tube, opposite the first end, may be mechanically coupled with tools and sensors within a wellbore. The electrical conductors may be electrically coupled with the tools and sensors, and electrically coupled with a control and monitoring system at the surface. The fiber optic cables may be optically coupled with the tools and sensors, and optically coupled with the control and monitoring system at the surface.

The present disclosure provides for a method. The method may include running a tool and sensor mechanically coupled with a multi-layer coiled tube down a wellbore from a location at the surface. The multi-layer coiled tube may include an inner coiled tube, an outer tube circumferentially and longitudinally surrounding the inner coiled tube, and conductors positioned between the inner coiled tube and the outer tube. The conductors may include electrical conductors and fiber optic cables. The electrical conductors may be electrically coupled with the tools and sensors, and electrically coupled with a control and monitoring system at the surface. The fiber optic cables may be optically coupled with the tools and sensors, and optically coupled with the control and monitoring system at the surface.

### BRIEF DESCRIPTION OF DRAWINGS

The present disclosure may be understood from the following detailed description when read with the accompanying figures. It is emphasized that, in accordance with the standard practice in the industry, various features may not be drawn to scale. In fact, the dimensions of the various features may be arbitrarily increased or reduced for clarity of discussion.

FIG. 1 depicts a cross-sectional view of a multi-layer coiled tube in accordance with certain embodiments of the present disclosure.

FIG. 2A depicts a coiled tubing manufacturing system in accordance with certain embodiments of the present disclosure.

FIG. 2B depicts a rotating die of the coiled tubing manufacturing system of FIG. 2A.

FIG. 3 depicts a flow chart of a coiled tubing manufacturing process in accordance with certain embodiments of the present disclosure.

FIGS. 4A-4H depict cross-sectional views showing manufacture of a multi-layer coiled tube in accordance with the coiled tubing manufacturing process of FIG. 3.

FIG. 5 depicts a coiled tubing manufacturing system in accordance with certain embodiments of the present disclosure.

FIG. 6 is a flow chart of a coiled tubing manufacturing process in accordance with certain embodiments of the present disclosure.

FIGS. 7A-7G depict cross-sectional views showing manufacture of a multi-layer coiled tube in accordance with the coiled tubing manufacturing process of FIG. 6.

FIGS. 8A-8D depict a first conductive layer in accordance with certain embodiments of the present disclosure.

FIG. 9 depicts a coiled tubing manufacturing system in accordance with certain embodiments of the present disclosure.

FIG. 10 is a flow chart of a coiled tubing manufacturing process in accordance with certain embodiments of the present disclosure.

FIGS. 11A-11G depict cross-sectional views showing manufacture of a multi-layer coiled tube in accordance with the coiled tubing manufacturing process of FIG. 10.

FIG. 12A depicts a first conductive layer in accordance with certain embodiments of the present disclosure.

FIG. 12B depicts a portion of channeled tape in accordance with certain embodiments of the present disclosure.

FIG. 12C depicts channeled tape in accordance with certain embodiments of the present disclosure.

FIG. 13 depicts a coiled tubing manufacturing system in accordance with certain embodiments of the present disclosure.

FIG. 14 is a flow chart of a coiled tubing manufacturing process in accordance with certain embodiments of the present disclosure.

FIGS. 15A-15G depict cross-sectional views showing manufacture of a multi-layer coiled tube in accordance with the manufacturing process of FIG. 14.

FIG. 16A depicts a coiled tubing system in accordance with certain embodiments of the present disclosure.

FIG. 16B is a diagram showing coupling between a multi-layer coiled tube and a tool, sensor, or combinations thereof in accordance with certain embodiments of the present disclosure.

FIG. 17 is a flow chart of a coiled tubing method in accordance with certain embodiments of the present disclosure.

### DETAILED DESCRIPTION

A detailed description will now be provided. The following disclosure includes specific embodiments, versions and examples, but the disclosure is not limited to these embodiments, versions or examples, which are included to enable a person having ordinary skill in the art to make and use the disclosure when the information in this application is combined with available information and technology. In addition, the present disclosure may repeat reference numerals and/or letters in the various examples. This repetition is for the purpose of simplicity and clarity and does not in itself dictate a relationship between the various embodiments and/or configurations discussed.

Various terms as used herein are shown below. To the extent a term used in a claim is not defined below, it should be given the broadest definition persons in the pertinent art have given that term as reflected in printed publications and issued patents. Further, unless otherwise specified, all compounds described herein may be substituted or unsubstituted and the listing of compounds includes derivatives thereof.

Further, various ranges and/or numerical limitations may be expressly stated below. It should be recognized that unless stated otherwise, it is intended that endpoints are to be interchangeable. Where numerical ranges or limitations are expressly stated, such express ranges or limitations should be understood to include iterative ranges or limitations of like magnitude falling within the expressly stated ranges or limitations, e.g., from about 1 to about 10 includes, 2, 3, 4, etc.; greater than 0.10 includes 0.11, 0.12, 0.13, etc.

Embodiments of the present disclosure relate to multi-layer coiled tubing having electrical and fiber optic components for use in drilling, milling, debris removal, fracturing, and other downhole operations in subterranean wells.

FIG. 1 depicts multi-layer coiled tube 10. Multi-layer coiled tube 10 may include inner coiled tube 12. In some embodiments, inner coiled tube 12 may be a continuous length of pipe. The walls of inner coiled tube 12 may a thickness of from about 0.01 inches to about 0.3 inches, or about 0.015 inches to about 0.2 inches, or about 0.05 inches to about 0.1 inches, for example. Inner coiled tube 12 may be formed of a metal such as steel, e.g. a low-alloy carbon-steel. In certain embodiments, inner coiled tube 12 may formed of or clad with an alloy such as INCONEL®, an austenite nickel-chromium-based alloy, which may provide chemical resistance to degradation. Central channel 14 may be formed within and surrounded by inner coiled tube 12. In operation, fluids, e.g. mud, may flow downhole from the surface of a wellsite through central channel 14.

Multi-layer coiled tube 10 may include conductors 18a and 18b. While shown in FIG. 1 as having two conductors 18a and 18b, multi-layer coiled tube 10 may include more or fewer than two conductors. Each of conductors 18a and 18b may include one or more electrical conductors, one or more fiber optic cables, or combinations thereof. Each conductor 18a and 18b may be an opto-electrical cable for providing both electrical power and telemetry. Electrical conductors of conductors 18a and 18b may include copper wire, a copper alloy wire, a steel wire, or an aluminum wire. Fiber optic cables of conductors 18a and 18b may be acrylate fibers, polyimide fibers, or silicone perfluoroalkoxy (PFA) fibers. In certain embodiments, conductors 18a and 18b may be helically wrapped about inner coiled tube 12. In some embodiments, multi-layer coiled tube 10 does not include any conductors 18a and 18b within central channel 14.

In some embodiments, multi-layer coiled tube 10 includes one or more conductive layers 20. Conductive layers 20 may include one or more layers of polymer such as extruded polymer, one or more layers of tape such as metallic tape or polymeric tape, or combinations thereof. Conductive layers 20 may include one or more layers of a polyetheretherketone (PEEK) tape, one or more layers of cabling tape, one or more layers of a metallic cladding tape, one or more layers of a polymer composed of polyetheretherketone (PEEK), one or more layers of silicone gel polymer, or combinations thereof. The metallic cladding tape may be composed of Zn, Ni, Mo or Fe. Cabling tape may be polyester tape; polyphenylene sulfide (PPS) tape; PEEK tape; glass-fiber tape; glass-fiber tape coated with polytetrafluoroethylene (PTFE); fluoropolymer tape such as TEFZEL1®, perfluoro-alkoxyalkane (PFA), metafluoro-alkoxyalkane (MFA), or fluorinated ethylene propylene (FEP); or tensile strength enhanced PTFE tape. In certain embodiments, conductors 18a and 18b are partially or fully surrounded by, contained within, and/or embedded within one or more conductive layers 20. Conductors 18a and 18b may be located within channels formed within and surrounded by one or more conductive layers 20. Conductive layers 20 may circumferentially and longitudinally surround inner coiled tube 12.

Multi-layer coiled tube 10 may include outer tube 22 circumferentially and longitudinally surrounding conductive layers 20 and inner coiled tube 12. Outer tube 22 may be formed of a metal such as steel, e.g. a low-alloy carbon-steel. In certain embodiments, outer tube 22 may be a seam-welded metallic tube including seam-weld 24. In some embodiments, outer tube 22 may be drawn down over one or more conductive layers 20 and inner coiled tube 12.

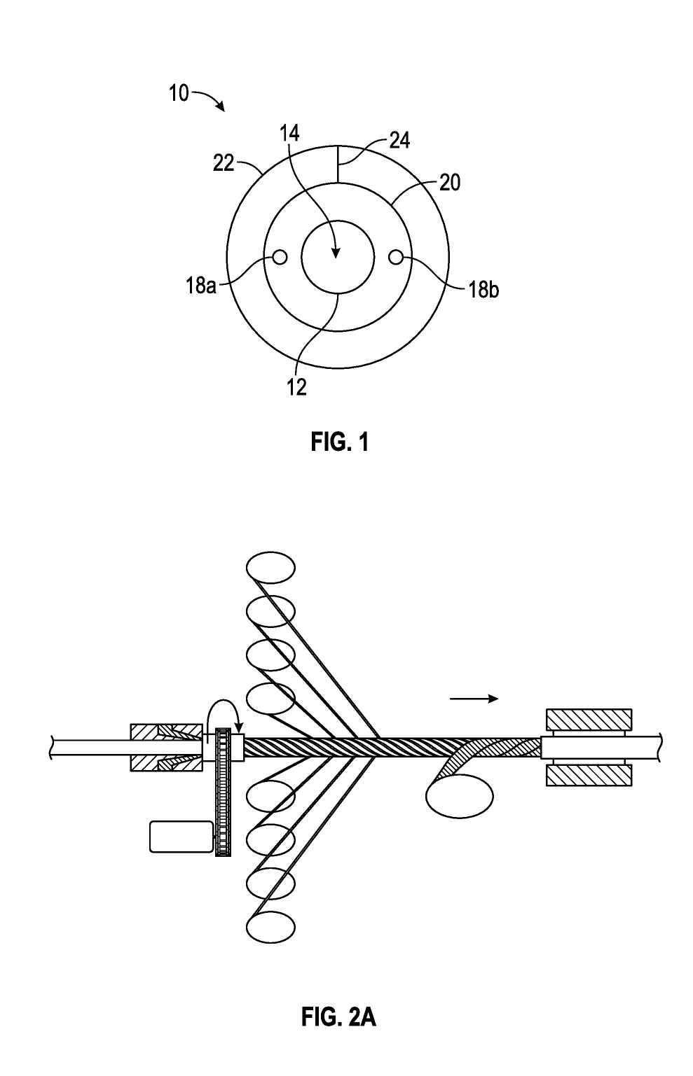

FIG. 2A depicts coiled tubing manufacturing system 1000a useful for manufacturing multi-layer coiled tube 10 in accordance with certain embodiments, and FIG. 2B depicts a detail of rotating die 26 of coiled tubing manufacturing system 1000a of FIG. 2A. Coiled tubing manufacturing system 1000a may include extruder 28. Extruder 28 may include central bore 1010 for receiving inner coiled tube 12, and polymer feed channels 1015 for receiving molten polymer. In operation, as inner coiled tube 12 passes through central bore 1010, molten polymer may flow through polymer feed channels 1015 into contact with inner coiled tube 12, forming first conductive layer 20a.

Coiled tubing manufacturing system 1000a may include rotating die 26, which may be mechanically coupled with extruder 28. In certain embodiments, rotating die 26 may be powered by electric motor 30 and driven by chain 32. Electric motor 30 may be mechanically coupled with gear 1020, gear 1020 may be mechanically coupled with chain 32, and chain 32 may be mechanically coupled with gear 1025 of rotating die 26. Rotating die 26 may include die hole 13 and one or more die teeth 36. In operation, inner coiled tube 12 with first conductive layer 20a may pass from central bore 1010 into die hole 13, and into contact with die teeth 36. As rotating die 26 rotates, die teeth 36 may rotate while in contact with first conductive layer 20a, forming channels 34 in first conductive layer 20a while first conductive layer 20a is in a pliable state after exiting extruder 28. Rotating die 26 may rotate in rotation direction 38, while inner coiled tube 12 moves along linear direction 40, but does not rotate. In some embodiments, helical channels 34 may be formed using a static die (not shown) while simultaneously rotating inner coiled tube 12 along rotational direction 38 and moving inner coiled tube 12 along linear direction 40. While channels 34 are depicted as extending helically within first conductive layer 20a and about inner coiled tube 12, one skilled in the art would understand that channels 34 may extend non-helically, such as linearly and parallel to linear direction 40. In certain embodiments, rotation of rotating die 26 about rotational direction 38 and movement of inner coiled tube 12 along linear direction 40 may be synchronized to form uniformly spaced channels 34. In other embodiments, channels 34 are not uniformly spaced.

Coiled tubing manufacturing system 1000a may include one or more rotating spools 46 having pre-formed conductors 19 spooled thereon. Pre-formed conductors 19 may be shaped to fit into channels 34. In some embodiments, coiled tubing manufacturing system 1000a includes one or more tape spools 45 having cabling tape 17 spooled thereon for forming second conductive layer 20b. Coiled tubing manufacturing system 1000a may include series of rollers 1050.

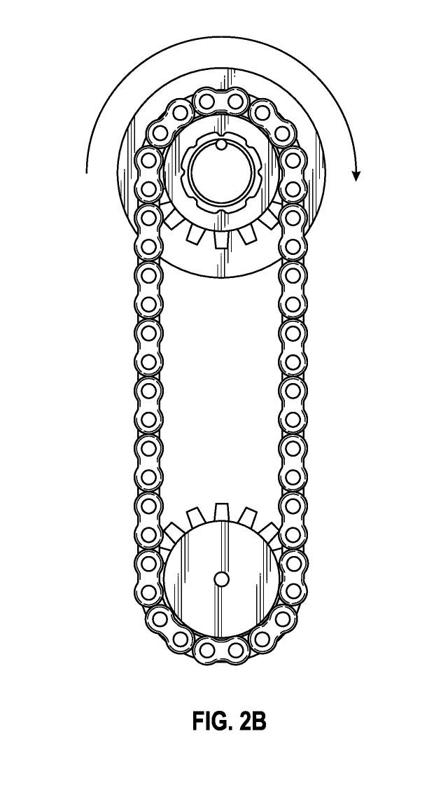

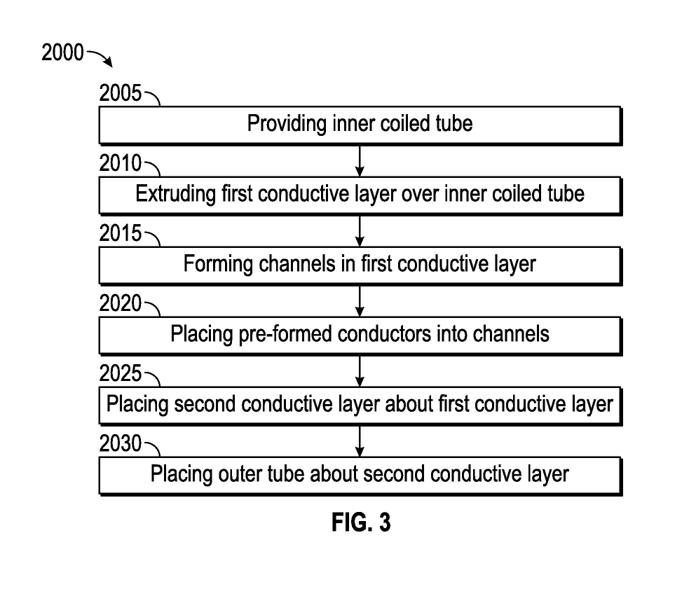

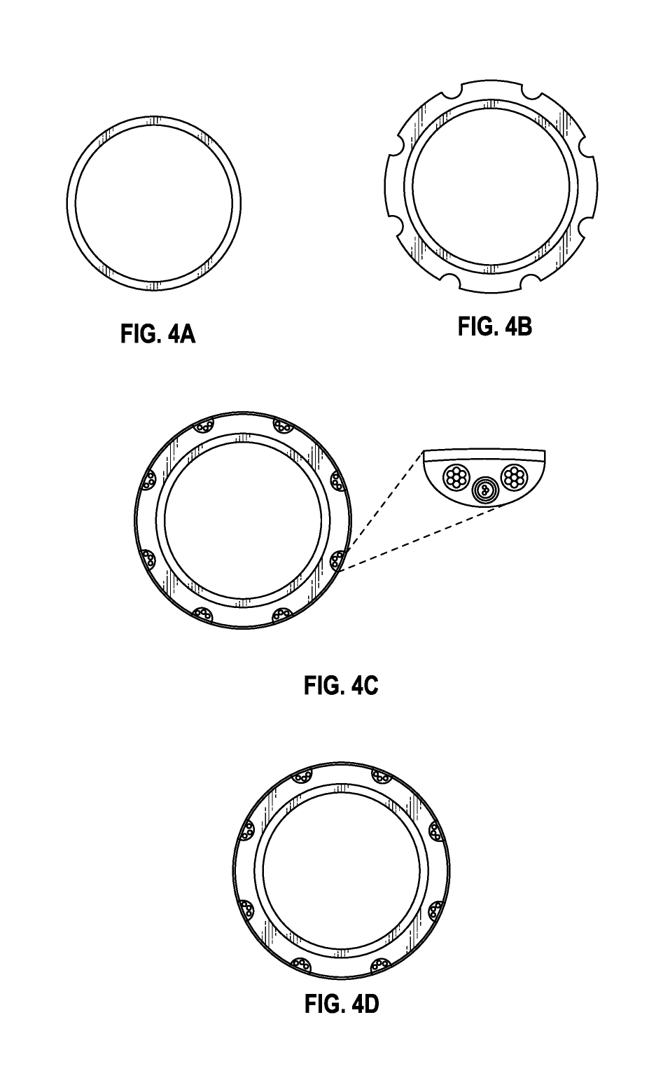

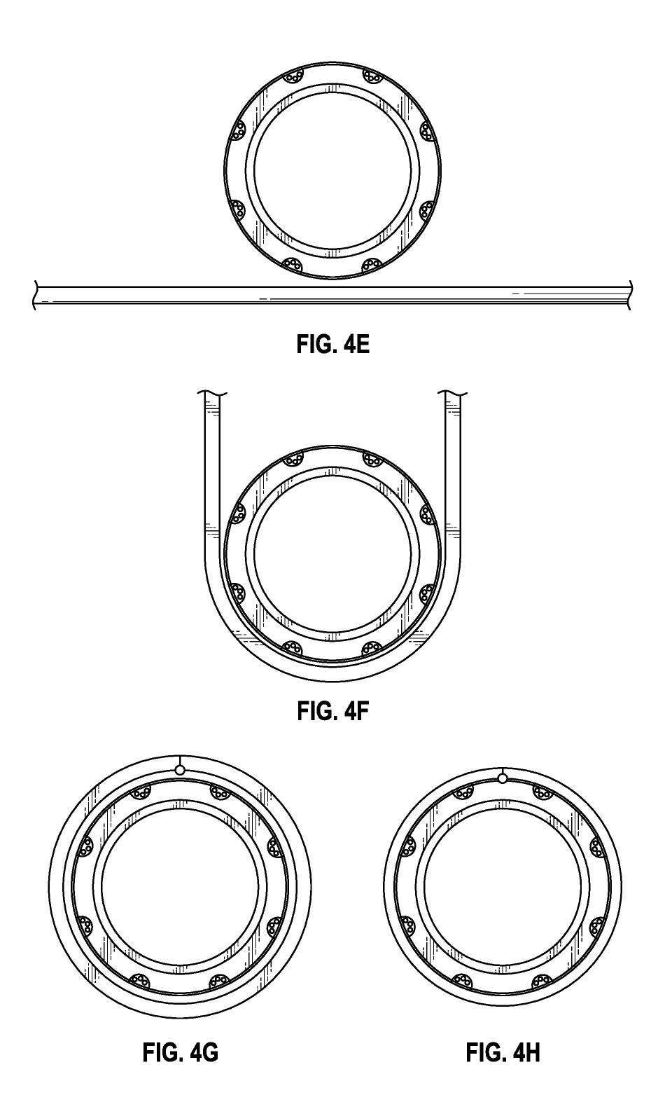

FIG. 3 is flow chart of coiled tubing manufacturing process 2000 useful for forming multi-layer coiled tube 10 in accordance with certain embodiments, and FIGS. 4A-4H depict cross-sectional views of multi-layer coiled tube 10 at successive stages during coiled tubing manufacturing process 2000. In some embodiments, coiled tubing manufacturing system 1000a may be used in coiled tubing manufacturing process 2000 to form multi-layer coiled tube 10 in accordance with FIGS. 4A-4H.

With reference to FIG. 3 and FIGS. 4A-4H, coiled tubing manufacturing process 2000 may include providing inner coiled tube 2005. Inner coiled tube 12 may have central channel as shown in FIG. 4A.

Coiled tubing manufacturing process 2000 may include extruding first conductive layer over inner coiled tube 2010. First conductive layer 20a may include a jacket of hard polymer over inner coiled tube 12 as shown in FIG. 4B. First conductive layer 20a may circumferentially and longitudinally surround inner coiled tube 12.

Coiled tubing manufacturing process 2000 may include forming channels in first conductive layer 2015. Channels 34 may be formed about an outer circumference of first conductive layer 20a, as shown in FIG. 4B.

Coiled tubing manufacturing process 2000 may include placing pre-formed conductors into channels 2020. Pre-formed conductors 19 may be shaped to fit into channels 34 as shown in FIG. 4C. Pre-formed conductors 19 may include insulated conductors 18 surrounded by soft polymer 42, such as a soft gel polymer, e.g. silicone gel polymer. Pre-formed conductors 19 may include layer of hard polymer 44, e.g. PEEK. With pre-formed conductors 19 placed into channels 34, layer of hard polymer 44 may be flush with the outer diameter of first conductive layer 20a. In operation, pre-formed conductors 19 may be placed into channels 34 by rotating spools 46 about inner coiled tube 12 with first conductive layer 20a.

Coiled tubing manufacturing process 2000 may include placing second conductive layer about first conductive layer 2025. A cross-sectional view of inner coiled tube 12 having first conductive layer 20a and second conductive layer 20b is shown in FIG. 4D. In some embodiments, second conductive layer 20b may be a layer of cabling tape 17 as shown in FIG. 2A. Second conductive layer 20b may retain pre-formed conductors 19 within channels 34. In certain embodiments, second conductive layer 20b is wrapped about an entirety of outer circumference of first conductive layer 20a. In other embodiments, second conductive layer 20b is wrapped about less than an entirety of outer circumference of first conductive layer 20a. In some embodiments, second conductive layer 20b may be wrapped about first conductive layer 20a counter-helically relative to the helical wrapping of first conductive layer 20a. In certain embodiments, adjacent segments of cabling tape 17 within second conductive layer 20b may abut or overlap one another when wrapped helically about inner coiled tube 12, providing full or substantially full coverage over the outer circumference of inner coiled tube 12.

Coiled tubing manufacturing process 2000 may include placing outer tube about second conductive layer 2030. In some embodiments, placing outer tube 22 about second conductive layer 20b includes placing metal sheet 21 adjacent inner coiled tube 12 having first conductive layer 20a and second conductive layer 20b as shown in FIG. 4E. Metal sheet 21 may be a continuous piece of metal, such as steel. Placing outer tube 22 about second conductive layer 20b may include using a series of shaping rollers 1050 to form metal sheet 21 into outer tube 22 at least partially circumferentially and longitudinally surrounding inner coiled tube 12, first conductive layer 20a and second conductive layer 20b as shown in FIG. 4F. Placing outer tube 22 about second conductive layer 20b may include seam-welding edges of metal sheet 23a and 23b of outer tube 22 together, forming seam-weld 24, completing formation of outer tube 22 as shown in FIG. 4G. Outer tube 22 may surround inner coiled tube 12, first conductive layer 20a and second conductive layer 20b, with interstitial space 25 located between outer tube 22 and second conductive layer 20b. Placing outer tube 22 about second conductive layer 20b may include drawing down outer tube 22 over inner coiled tube 12, first conductive layer 20a and second conductive layer 20b to reduce or eliminate interstitial space 25, completing multi-layer coiled tube 10 as shown in FIG. 4H.

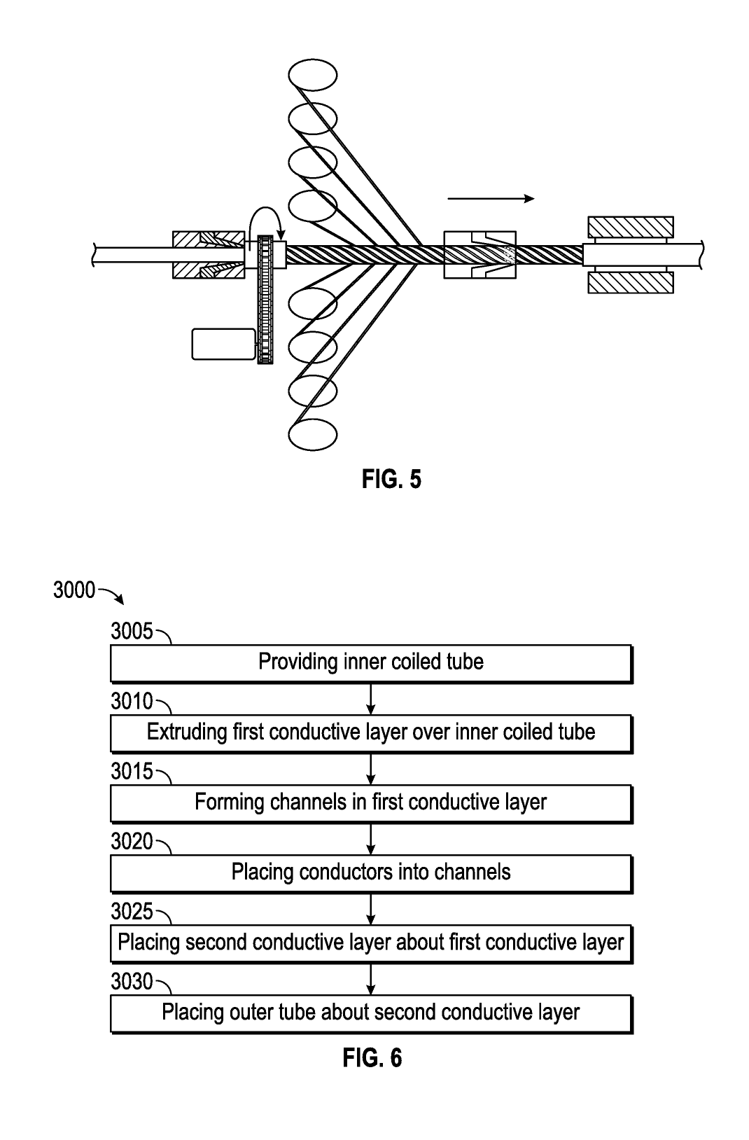

FIG. 5 depicts coiled tubing manufacturing system 1000b useful for manufacturing multi-layer coiled tube 10 in accordance with certain embodiments. Coiled tubing manufacturing system 1000b may include extruder 28. Extruder 28 may include central bore 1010 for receiving inner coiled tube 12, and polymer feed channels 1015 for receiving molten polymer. In operation, as inner coiled tube 12 passes through central bore 1010, molten polymer may flow through polymer feed channels 1015 into contact with inner coiled tube 12, forming first conductive layer 20a.

Coiled tubing manufacturing system 1000b may include rotating die 26, which may be mechanically coupled with extruder 28. In certain embodiments, rotating die 26 may be powered by electric motor 30 and driven by chain 32. Extruder 28 and rotating die 26 may operate in the same manner as described with respect to FIGS. 2A and 2B to form first conductive layer 20a on inner coiled tube 12 having helical channels 34.

Coiled tubing manufacturing system 1000b may include one or more rotating spools 47 having conductors 18 spooled thereon. In some embodiments, coiled tubing manufacturing system 1000b includes one second extruder 29. Second extruder 29 may include central bore 1021 for receiving inner coiled tube 12 with first conductive layer 20a, and polymer feed channels 1026 for receiving molten polymer. In operation, as inner coiled tube 12 first conductive layer 20a passes through central bore 1021, molten polymer may flow through polymer feed channels 1026 into contact with inner coiled tube 12, forming second conductive layer 20b.

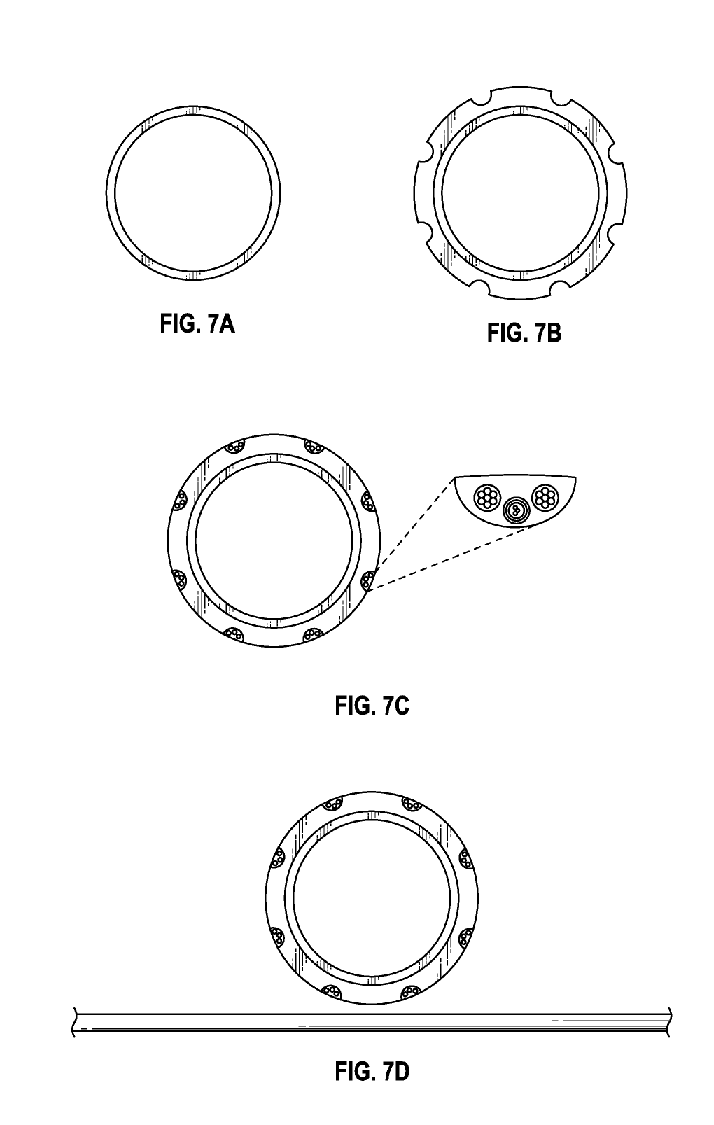

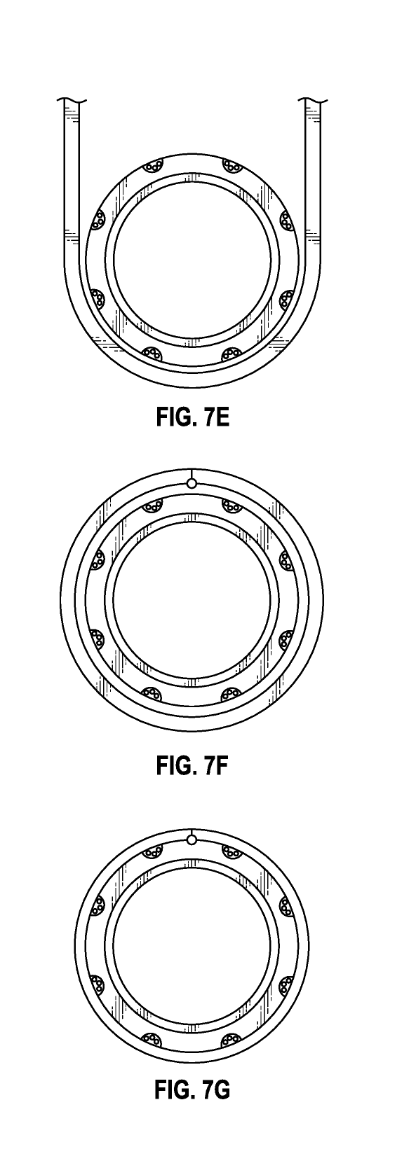

FIG. 6 is flow chart of coiled tubing manufacturing process 3000 useful for forming multi-layer coiled tube 10 in accordance with certain embodiments, and FIGS. 7A-7G depict cross-sectional views of multi-layer coiled tube 10 at successive stages during coiled tubing manufacturing process 3000. In some embodiments, coiled tubing manufacturing system 1000b may be used in coiled tubing manufacturing process 3000 to form multi-layer coiled tube 10 in accordance with FIGS. 7A-7G.

With reference to FIG. 6 and FIGS. 7A-7G, coiled tubing manufacturing process 3000 may include providing inner coiled tube 3005. Inner coiled tube 12 may have central channel 14 as shown in FIG. 7A.

Coiled tubing manufacturing process 3000 may include extruding first conductive layer over inner coiled tube 3010. First conductive layer 20a may form a jacket of hard polymer over inner coiled tube 12 as shown in FIG. 7B. First conductive layer 20a may circumferentially and longitudinally surround inner coiled tube 12.

Coiled tubing manufacturing process 3000 may include forming channels in first conductive layer 3015. Channels 34 may be formed about an outer circumference of first conductive layer 20a, as shown in FIG. 7B.

Coiled tubing manufacturing process 3000 may include placing conductors into channels 3020. Conductors 18 may be placed into channels 34 by rotating spools 47 about inner coiled tube 12 with first conductive layer 20a. In some embodiments, conductors 18 may be insulated.

Coiled tubing manufacturing process 3000 may include placing second conductive layer about first conductive layer 3025. Placing second conductive layer 20b about first conductive layer 20a may include extruding soft polymer 42 into channels 34 and over conductors 18 as shown in FIG. 7C, such as by using extruder 29. Soft polymer 42 may be a soft gel polymer, e.g. silicone gel polymer. Soft polymer 42 may fill interstitial space within channels 34 between conductors 18 and first conductive layer 20a. Soft polymer 42 may retain conductors 18 in place within channels 34.

Coiled tubing manufacturing process 3000 may include placing outer tube about second conductive layer 3030. In some embodiments, placing outer tube 22 about second conductive layer 20b includes placing metal sheet 21 adjacent inner coiled tube 12 having first conductive layer 20a and second conductive layer 20b as shown in FIG. 7D. Metal sheet 21 may be a continuous piece of metal, such as steel. Placing outer tube 22 about second conductive layer 20b may include using a series of shaping rollers 1050 to form metal sheet 21 into outer tube 22 at least partially circumferentially and longitudinally surrounding inner coiled tube 12, first conductive layer 20a and second conductive layer 20b as shown in FIG. 7E. Placing outer tube 22 about second conductive layer 20b may include seam-welding edges of metal sheet 23a and 23b of outer tube 22 together, forming seam-weld 24, completing formation of outer tube 22 as shown in FIG. 7F. Outer tube 22 may surround inner coiled tube 12, first conductive layer 20a and second conductive layer 20b, with interstitial space 25 located between outer tube 22 and second conductive layer 20b. Placing outer tube 22 about second conductive layer 20b may include drawing down outer tube 22 over inner coiled tube 12, first conductive layer 20a and second conductive layer 20b to reduce or eliminate interstitial space 25, completing multi-layer coiled tube 10 as shown in FIG. 7G.

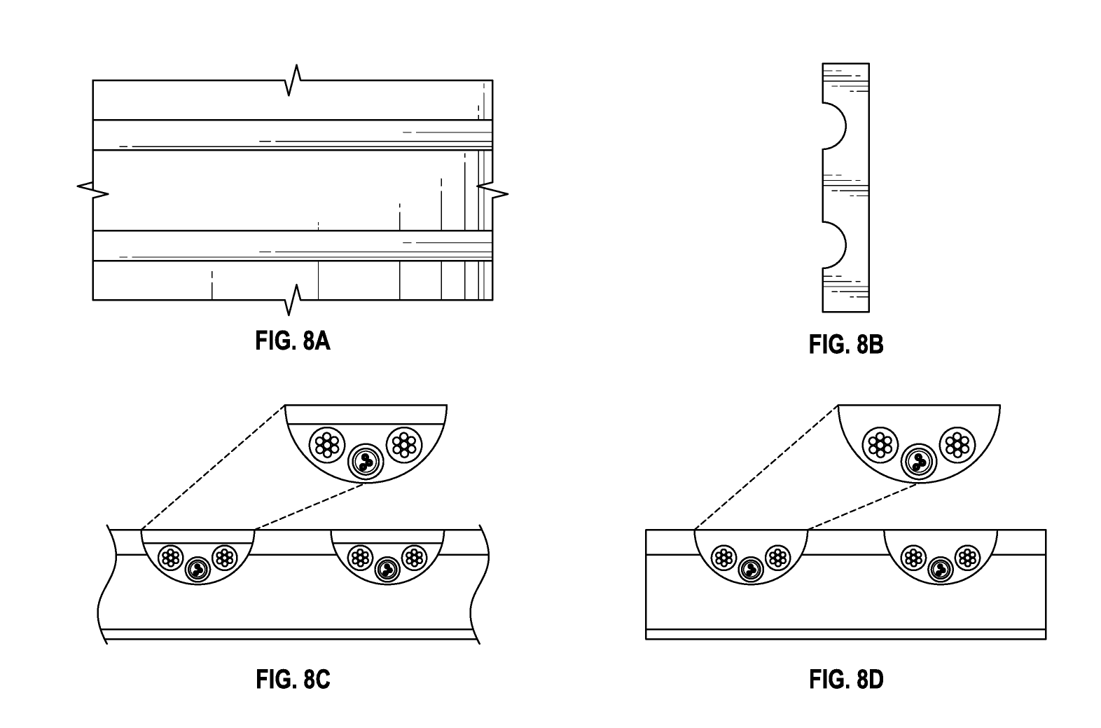

FIGS. 8A-8D depict first conductive layer 20a in accordance with certain embodiments. First conductive layer 20a may be composed of surface channeled tape 50, e.g. metallic tape, shaped to have channels 34 formed therein. As shown in FIG. 8B, channels 34 may have a semi-circular cross-sectional profile and be formed on an outer surface of surface channeled tape 50. In some embodiments, pre-formed conductors 19 may be placed into channels 34 as shown in FIG. 8C. In other embodiments, conductors 18 may be placed into channels 34 and soft polymer 42 may be extruded into channels 34 over conductors 18 as shown in FIG. 8D.

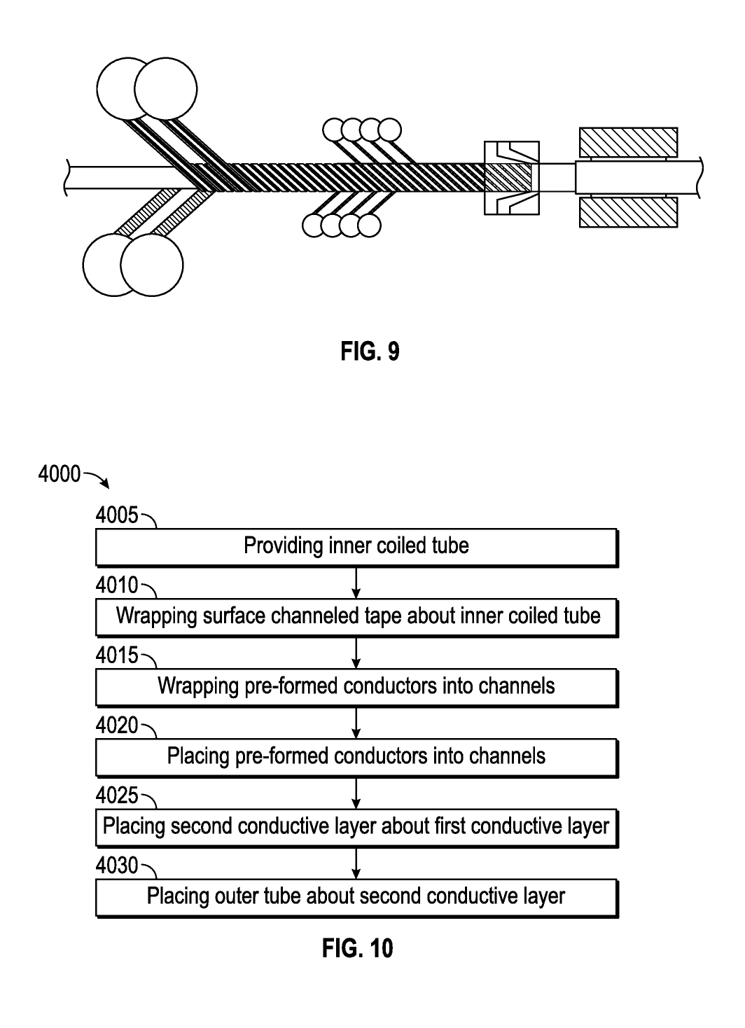

FIG. 9 depicts coiled tubing manufacturing system 1000c useful for manufacturing multi-layer coiled tube 10 in accordance with certain embodiments. In some embodiments, coiled tubing manufacturing system 1000c may be used to place first conductive layer 20a in accordance with FIGS. 8A-8D onto inner coiled tube 12. Coiled tubing manufacturing system 1000c may include spools 52 of surface channeled tape 50a-50d, for wrapping surface channeled tape 50a-50d helically about inner coiled tube 12 to form first conductive layer 20a. In certain embodiments, adjacent segments of surface channeled tape 50a-50d may abut or overlap one another when wrapped helically about inner coiled tube 12, providing full or substantially full coverage over the outer circumference of inner coiled tube 12. Surface channeled tape 50c may abut or overlap surface channeled tape 50b when wrapped helically about inner coiled tube 12, forming first conductive layer 20a. First conductive layer 20a may circumferentially and longitudinally surround inner coiled tube 12. With first conductive layer 20a wrapped helically about inner coiled tube 12, channels 34 may extend helically about inner coiled tube 12.

Coiled tubing manufacturing system 1000c may include spools 56, which may have pre-formed conductors 19 spooled thereon for wrapping pre-formed conductors 19 into channels 34.

Coiled tubing manufacturing system 1000c may include second layer extruder 51 for extruding second conductive layer 20b over first conductive layer 20a, channels 34 and pre-formed conductors 19. Second layer extruder 51 may include central bore 1030 for receiving inner coiled tube 12 with first conductive layer 20a, and polymer feed channels 1035 for receiving molten polymer. As inner coiled tube 12 with first conductive layer 20a passes through central bore 1030, molten polymer may be extruded onto inner coiled tube 12 with first conductive layer 20a, forming second conductive layer 20b.

Coiled tubing manufacturing system 1000c may include series of rollers 1050 for forming outer tube 22 about second conductive layer 20b.

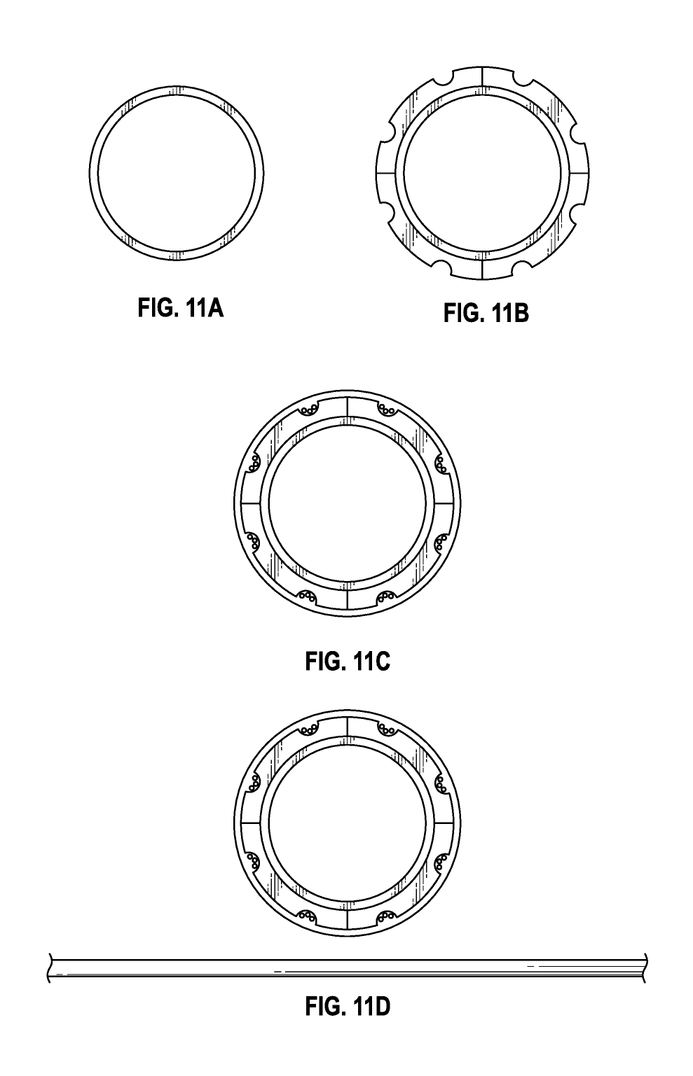

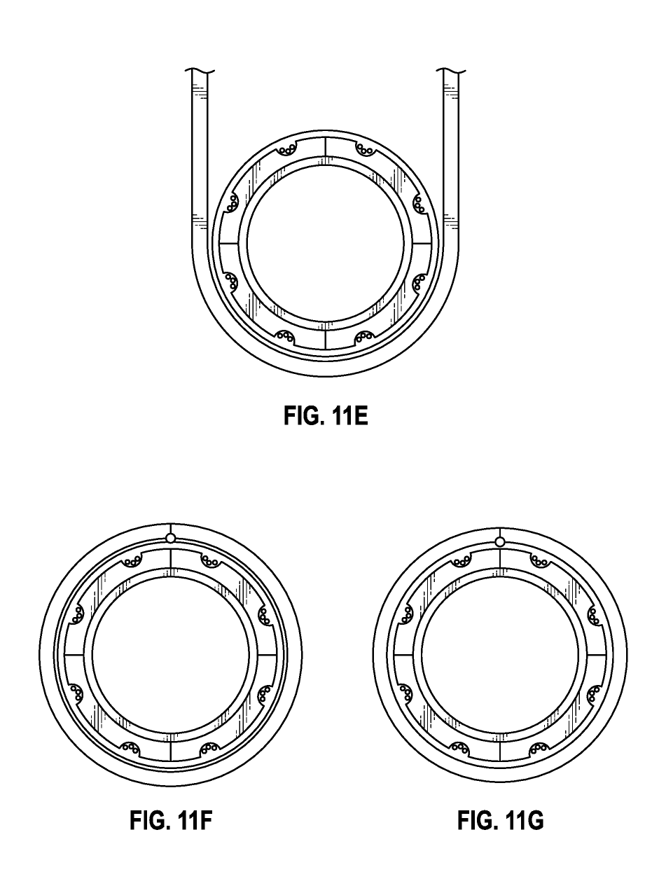

FIG. 10 is a flow chart of coiled tubing manufacturing process 4000 in accordance with certain embodiments. FIGS. 11A-11G depict cross-sectional views showing manufacture of multi-layer coiled tube 10 in accordance with coiled tubing manufacturing process 4000 of FIG. 10.

Coiled tubing manufacturing process 4000 may include providing inner coiled tube 4005. Inner coiled tube 12 may include central channel 14 as shown in FIG. 11A.

Coiled tubing manufacturing process 4000 may include wrapping surface channeled tape about inner coiled tube 4010. Wrapping surface channeled tape 50 about inner coiled tube 12 may form first conductive layer 20a as shown in FIG. 11B. In operation, surface channeled tape 50a-50d may be wrapped helically from spools 52 about inner coiled tube 12. With first conductive layer 20a wrapped helically about inner coiled tube 12, channels 34 may extend helically about inner coiled tube 12.

Coiled tubing manufacturing process 4000 may include wrapping pre-formed conductors into channels 4015. Pre-formed conductors 19 may be positioned in each channel 34 as shown in FIG. 11C. Pre-formed conductors 19 may be placed, e.g. cabled, into channels 34 from spools 56.

Coiled tubing manufacturing process 4000 may include placing second conductive layer about first conductive layer 4025. Second conductive layer 20b may be extruded over first conductive layer 20a, channels 34 and pre-formed conductors 19 as shown in FIG. 11C using second layer extruder 51. Second conductive layer 20b may be composed of a soft polymer such as a soft gel polymer, e.g. silicone gel polymer. Portions of second conductive layer 20b may fill interstitial space, if any, within channels 34 between pre-formed conductors 19 and first conductive layer 20a. Second conductive layer 20b may retain pre-formed conductors 19 in place within channels 34.

Coiled tubing manufacturing process 4000 may include placing outer tube about second conductive layer 4030. Metal sheet 21, e.g. steel, may be placed adjacent inner coiled tube 12 with first conductive layer 20a and second conductive layer 20b as shown in FIG. 11D. Using series of shaping rollers 1050, metal sheet 21 may be formed into outer tube 22 at least partially circumferentially and longitudinally surrounding inner coiled tube 12, first conductive layer 20a and second conductive layer 20b as shown in FIG. 11E. Edges of metal sheet 23a and 23b may be seam-welded together, forming seam-weld 24, completing formation of outer tube 22 as shown in FIG. 11F.

As shown in FIG. 11F, outer tube 22 surrounds inner coiled tube 12, first conductive layer 20a and second conductive layer 20b, with interstitial space 31 located between outer tube 22 and second conductive layer 20b. Outer tube 22 may be drawn down over inner coiled tube 12, first conductive layer 20a and second conductive layer 20b to reduce or eliminate interstitial space 31, completing multi-layer coiled tube 10 as shown in FIG. 11G. In some embodiments, drawing down outer tube 22 forces bead 33 of seam-weld 24 into contact with second conductive layer 20b. In such embodiments, soft polymer of second conductive layer 20b may at least partially protect pre-formed conductors 19 from damage that may be caused by contact with outer tube 22 during drawing down.

While shown and described as pre-formed conductors 19 in FIGS. 10 and 11A-11G, in other embodiments conductors 18 may be placed into channels 34 and soft polymer 42 may be extruded into channels 34 over conductors 18.

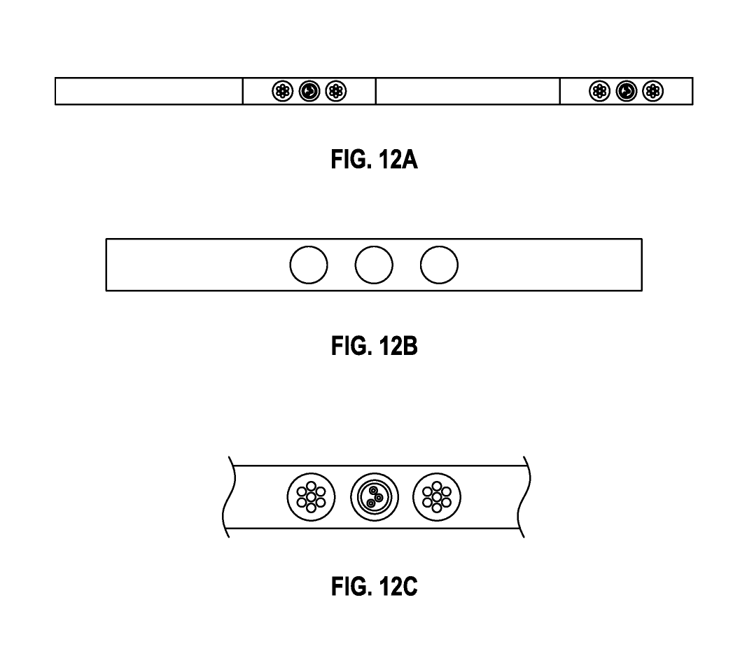

FIG. 12A depicts first conductive layer 20a in accordance with certain embodiments. First conductive layer 20a may be composed of one or more tapes. First conductive layer 20a may be composed of channeled tape 60 as shown in FIGS. 12A-12C and metallic tape 62. Channeled tape 60 and metallic tape 62 may be arranged within first conductive layer 20a in an alternating configuration, as shown in FIG. 12A.

Channeled tape 60 may be composed of material 61 as shown in FIG. 12B, such as a metal or a polymer. Channeled tape 60 may have one or more channels 34 formed therein. Each channel 34 may be defined by channel circumference 35. Material 61 may surround channels 34 about an entirety of channel circumference 35. Channels 34 may be through holes extending through material 61 of channeled tape 60. In certain embodiments, as shown in FIG. 12B, channels 34 may have a circular cross-sectional profile.

One or more pre-formed conductors 19 may be located within channels 34. While shown and described as pre-formed conductors 19, in other embodiments conductors 18 may be placed into channels 34 and soft polymer 42 may be placed into channels 34 over conductors 18.

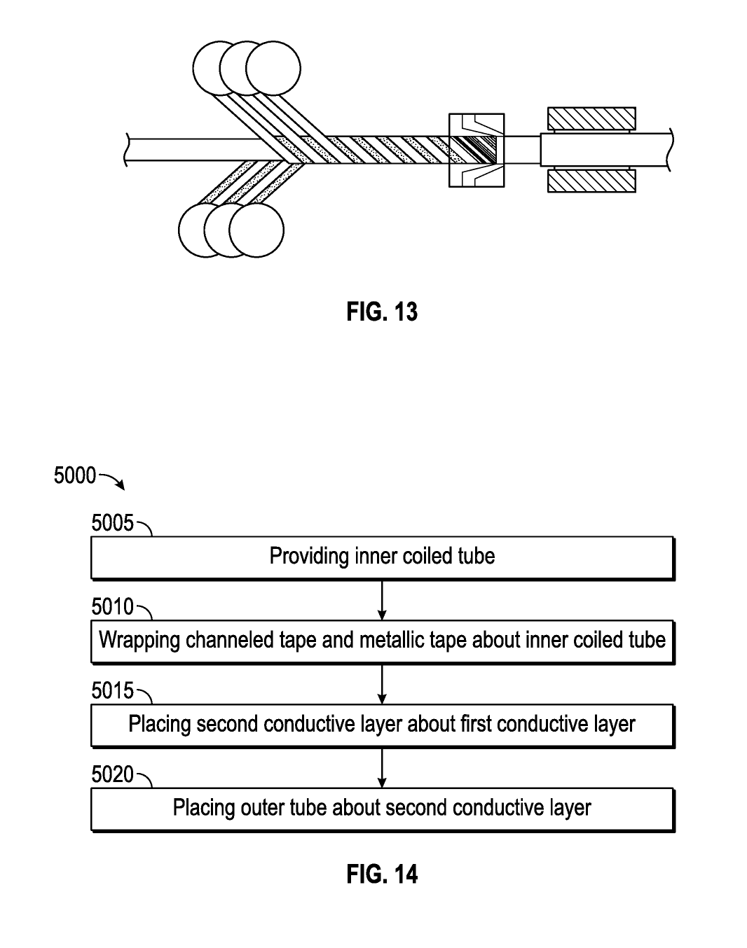

FIG. 13 depicts coiled tubing manufacturing system 1000d useful for forming multi-layer coiled tube 10 using first conductive layer 20a in accordance with FIGS. 12A-12C. Coiled tubing manufacturing system 1000d may include channeled tape spools 70 having channeled tape 60 spooled thereon, metallic tape spools 72 having metallic tape 62 spooled thereon, extruder 75 and series of rollers 1050. Extruder 75 may include central bore 1060 for receiving inner coiled tube 12 having first conductive layer 20a. Extruder 75 may include polymer feed channels 1065 for providing molten polymer onto inner coiled tube 12 having first conductive layer 20a as inner coiled tube 12 having first conductive layer 20a passes through central bore 1060, forming second conductive layer 20b. Series of rollers 1050 may operate to shape outer tube 22, forming multi-layer coiled tubing 10.

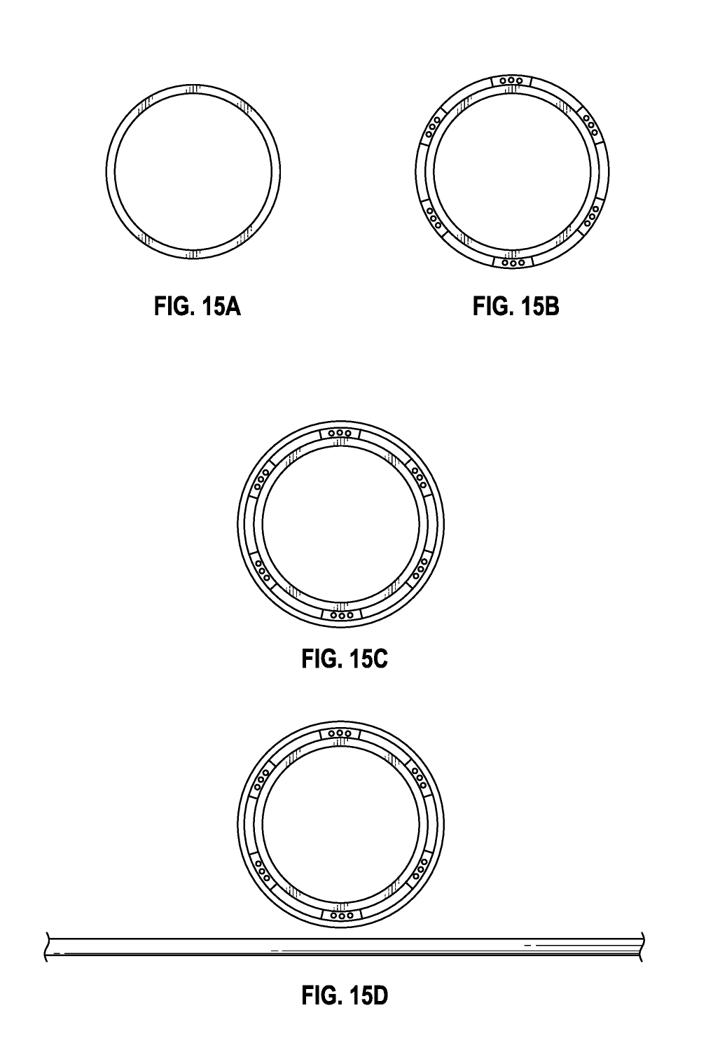

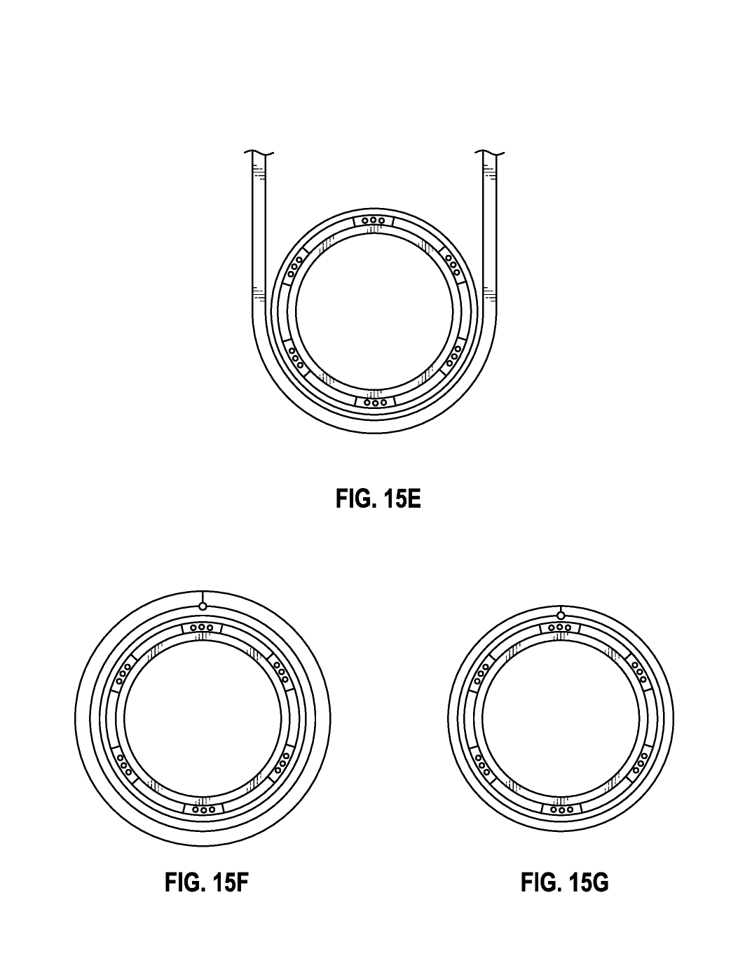

FIG. 14 depicts coiled tubing manufacturing process 5000, and FIGS. 15A-15G depict cross-sectional views showing manufacture of multi-layer coiled tube 10 in accordance with coiled tubing manufacturing process 5000.

Coiled tubing manufacturing process 5000 may include providing inner coiled tube 5005. Inner coiled tube 12 may have central channel 14 as shown in FIG. 15A.

Coiled tubing manufacturing process 5000 may include wrapping channeled tape and metallic tape about inner coiled tube 5010. Wrapping channeled tape 60 and metallic tape 62 about inner coiled tube 12 from channeled tape spools 70 and metallic tape spools 72 may form first conductive layer 20a, as shown in FIG. 15B. Channeled tape 60 and metallic tape 62 may be wrapped helically from spools 70 and 72, respectively, about inner coiled tube 12, forming first conductive layer 20a. Channeled tape 60 and metallic tape 62 may be wrapped helically about inner coiled tube 12 in an alternating pattern, as shown in FIG. 15B, such that segments of channeled tape 60 are helically wrapped adjacent segments of metallic tape 62. In certain embodiments, segments of channeled tape 60 that are adjacent segments of metallic tape 62 in first conductive layer 20a may abut or overlap one another, providing full or substantially full coverage over the outer circumference of inner coiled tube 12. First conductive layer 20a may circumferentially and longitudinally surround inner coiled tube 12. With first conductive layer 20a wrapped helically about inner coiled tube 12, pre-formed conductors 19 may extend helically about inner coiled tube 12.

Coiled tubing manufacturing process 5000 may include placing second conductive layer about first conductive layer 5015. Second conductive layer 20b may be extruded over first conductive layer 20a as shown in FIG. 15C from extruder 75. Second conductive layer 20b may be composed of a soft polymer such as a soft gel polymer, e.g. silicone gel polymer. Second layer conductive 20b may retain first conductive layer 20a in place about inner coiled tube 12.

Coiled tubing manufacturing process 5000 may include placing outer tube about second conductive layer 5020. Metal sheet 21, such as steel, may be placed adjacent inner coiled tube 12 with first conductive layer 20a and second conductive layer 20b as shown in FIG. 15D. Series of shaping rollers 1050 may be used to form metal sheet 21 into outer tube 22 at least partially circumferentially and longitudinally surrounding inner coiled tube 12, first conductive layer 20a and second conductive layer 20b as shown in FIG. 15E. Edges of metal sheet 23a and 23b may be seam-welded together, forming seam-weld 24, completing formation of outer tube 22 as shown in FIG. 15F.

As shown in FIG. 15F, outer tube 22 surrounds inner coiled tube 12, first conductive layer 20a and second conductive layer 20b, with interstitial space 73 located between outer tube 22 and second conductive layer 20b. Outer tube 22 may be drawn down over inner coiled tube 12, first conductive layer 20a and second conductive layer 20b to reduce or eliminate interstitial space 73, completing multi-layer coiled tube 10 as shown in FIG. 15G. In some embodiments, drawing down outer tube 22 forces bead 33 of seam-weld 24 into contact with second conductive layer 20b. In such embodiments, the soft polymer of second conductive layer 20b may at least partially protect pre-formed conductors 19 from damage that may be caused by force exerted from outer tube 22 during drawing down.

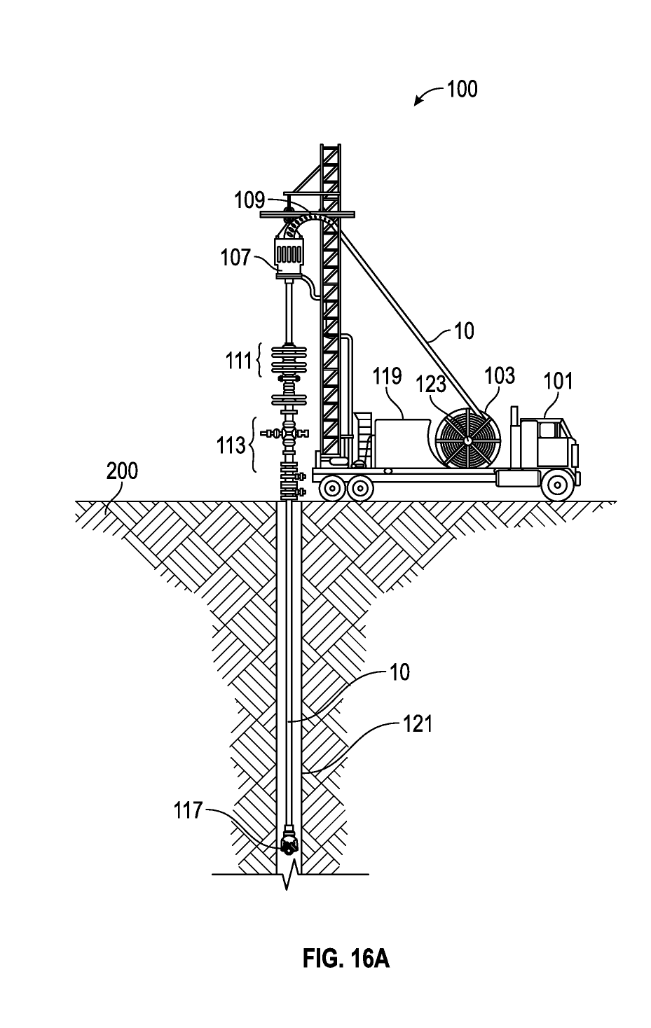

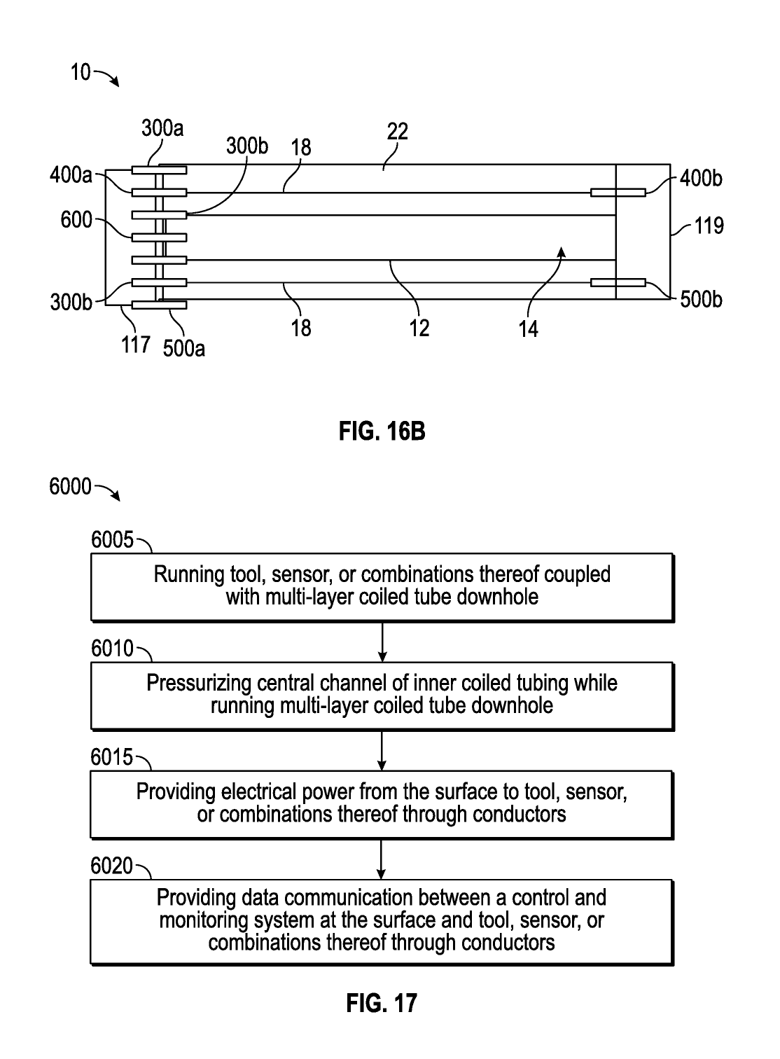

FIG. 16A depicts coiled tubing system 100 in accordance with certain embodiments of the present disclosure, and FIG. 16B is a diagram of mechanical, electrical, optical, and fluid couplings of multi-layer coiled tube 10 in coiled tubing system 100. Coiled tubing system 100 may be used to provide coiled tubing services or operations in a subterranean well, e.g. workover and well-intervention operations. Coiled tubing system 100 may include tubing reel 103 located at surface 200. Coiled tubing system 100 may include multi-layer coiled tube 10, as described herein. Multi-layer coiled tube 10 may be wrapped about tubing reel 103 at a first end of multi-layer coiled tube 10. A second end of multi-layer coiled tube 10, opposite the first end, may be mechanically coupled with tool, sensor, or combinations thereof 117 via mechanical couplers 300a and 300b. Mechanical couplers 300a may provide mechanical coupling between tool, sensor, or combinations thereof 117 and outer tube 22. Mechanical couplers 300b may provide mechanical coupling between tool, sensor, or combinations thereof 117 and inner coiled tube 12. Mechanical couplers 300a and 300b may be any mechanical coupler well known to those of ordinary skill in the art.

Conductors 18 of multi-layer coiled tube 10 may be electrically coupled with tool, sensor, or combinations thereof 117 within wellbore 121 via electrical coupler 400a, and with control and monitoring system 119 via electrical coupler 400b. Electrical couplers 400a and 400b may be any electrical coupler well known to those of ordinary skill in the art.

Conductors 18 of multi-layer coiled tube 10 may be optically coupled with tool, sensor, or combinations thereof 117 within wellbore 121 via electrical coupler 500a, and with control and monitoring system 119 via electrical coupler 500b. Optical couplers 500a and 500b may be any optical coupler well known to those of ordinary skill in the art.

Central channel 14 of inner coiled tube 12 may be fluidly coupled with tool, sensor, or combinations thereof 117 via fluid coupler 600. Fluid coupler 600 may be any fluid coupler well known to those of ordinary skill in the art. Central channel 14 may provide mud to a mud operated drill bit of tool, sensor or combinations thereof 117.

In some embodiments, coiled tubing system 100 includes truck, skid, and/or trailer 101 for transporting tubing reel 103. In some embodiments, one end of multi-layer coiled tube 10 may terminate at a center axis of tubing reel 103 in reel plumbing apparatus 123 that enables fluids to be pumped into central channel 14 of multi-layer coiled tube 10 while permitting tubing reel 113 to rotate. Injector head 107 and gooseneck 109 may be used by methods well known to those of ordinary skill in the art to inject multi-layer coiled tube 10 into wellbore 121. In some embodiments, injector head 107 injects multi-layer coiled tube 10 into wellbore 121 through surface well control hardware, such as blow out preventer stack 111 and master control valve 113.

Control and monitoring system 119 may include a computer, and may be coupled with injector head 107 and tubing reel 103 by methods well known to those of ordinary skill in the art for controlling the injection of multi-layer coiled tube 10 into wellbore 121. Control and monitoring system 119 may also be used for controlling and monitoring operation of tool, sensor, or combinations thereof 117. For example control and monitoring system 119 may collect data transmitted to from tool, sensor, or combinations thereof 117.

Tool, sensor, or combinations thereof 117 may include temperature sensors, pressure sensors, displacement sensors, flow sensors, level sensors, magnetic and electric field sensors, rotation rate sensors, gyroscopes, cameras, feelers, chemical analyzers, valves, drill bits, mills, mud motors, or any other downhole tool or sensor, including those well known to those of ordinary skill in the art.

With reference to FIGS. 16A, 16B and 17, coiled tubing method 6000 may include running tool, sensor, or combinations thereof coupled with multi-layer coiled tube downhole 6005. Tool, sensor, or combinations thereof 117 may be mechanically, fluidly, electrically, and optically coupled with multi-layer coiled tube 10, and may be run downhole into wellbore 121 from a location at surface 200.

Coiled tubing method 6000 may include pressurizing central channel of inner coiled tubing while running multi-layer coiled tube downhole 6010. Central channel 14 of inner coiled tube 12 may be pressurized while running multi-layer coiled tube 10 down wellbore 121, as shown in FIGS. 16A and 16B. Without being bound by theory, pressurization of central channel 14 may minimize the possibility of pressure damage to multi-layer coiled tube 10 while running multi-layer coiled tube 10 downhole. In some embodiments, central channel 14 of inner coiled tube 12 is pressurized to a predetermined pressure. The predetermined pressure may range from 200 psi to 20,000 psi, or from 350 psi to 15,000 psi, or from 500 psi to 10,000 psi, or from 1,000 psi to 7,500 psi, or from 2,500 psi to 5,000 psi.

Coiled tubing method 6000 may include providing electrical power from the surface to tool, sensor, or combinations thereof through conductors 6015. Coiled tubing method 6000 may include providing data communication between a control and monitoring system at the surface and tool, sensor, or combinations thereof through conductors 6020. As shown in FIGS. 16A and 16B, electrical power may be provided from surface 200 to tool, sensor, or combinations thereof 117 through conductors 18, and data communication may be provided between control and monitoring system 119 at surface 200 and tool, sensor, or combinations thereof 117 through conductors 18.

Depending on the context, all references herein to the “disclosure” may in some cases refer to certain specific embodiments only. In other cases it may refer to subject matter recited in one or more, but not necessarily all, of the claims. While the foregoing is directed to embodiments, versions and examples of the present disclosure, which are included to enable a person of ordinary skill in the art to make and use the disclosures when the information in this patent is combined with available information and technology, the disclosures are not limited to only these particular embodiments, versions and examples. Other and further embodiments, versions and examples of the disclosure may be devised without departing from the basic scope thereof and the scope thereof is determined by the claims that follow.

What is claimed is:

1. A multi-layer coiled tube comprising:
an inner coiled tube;
an outer tube circumferentially and longitudinally surrounding the inner coiled tube; and
conductors positioned between the inner coiled tube and the outer tube, the conductors comprising electrical conductors and fiber optic cables.

2. The multi-layer coiled tube of claim 1, wherein the conductors are helically wrapped about the inner coiled tube.

3. The multi-layer coiled tube of claim 1, comprising one or more conductive layers of polymer or tape located between the inner coiled tube and the outer tube, wherein the conductors are partially or fully surrounded by, contained within, or embedded within the one or more conductive layers of polymer or tape.

4. The multi-layer coiled tube of claim 3, wherein channels are formed within the one or more conductive layers of polymer or tape, and wherein the conductors are located within the channels.

5. The multi-layer coiled tube of claim 3, wherein the one or more conductive layers of polymer or tape comprises a first conductive layer of extruded polymer or tape circumferentially and longitudinally surrounding the inner coiled tube, wherein the outer tube circumferentially and longitudinally surrounds the first conductive layer, the first conductive layer comprising channels formed therein, and wherein the conductors are located within the channels.

6. The multi-layer coiled tube of claim 5, wherein a polymer fills interstitial spaces within the channels between the conductors and the first conductive layer.

7. The multi-layer coiled tube of claim 5, comprising a second conductive layer of extruded polymer or tape, the second conductive layer longitudinally and circumferentially surrounding the channels and the first conductive layer.

8. The multi-layer coiled tube of claim 5, wherein the channels are formed within the first conductive layer about an outer circumference of the first conductive layer.

9. The multi-layer coiled tube of claim 3, wherein the one or more conductive layers of polymer or tape comprises a first conductive layer comprising channeled tape helically wrapped around the inner coiled tube, wherein channels are formed within the channeled tape as through holes extending through the channeled tape, and wherein the conductors are located within the channels.

10. The multi-layer coiled tube of claim 9, wherein the first conductive layer further comprises a metallic tape, wherein the channeled tape and the metallic tape are wrapped helically about the inner coiled tube in an alternating pattern.

11. The multi-layer coiled tube of claim 10, wherein the one or more conductive layers of polymer or tape comprise a second conductive layer of extruded polymer longitudinally and circumferentially surrounding the first conductive layer.

12. The multi-layer coiled tube of claim 3, wherein the one or more conductive layers of polymer or tape comprise a first conductive layer comprising a surface channeled tape helically wrapped around the inner coiled tube, the surface channeled tape comprising channels formed on an outer surface thereof, and wherein the conductors are located within the channels.

13. The multi-layer coiled tube of claim 12, wherein the one or more conductive layers of polymer or tape comprise comprising a second conductive layer of extruded polymer or tape, the second conductive layer longitudinally and circumferentially surrounding the first conductive layer.

14. The multi-layer coiled tube of claim 1, wherein the outer tube is a seam-welded metallic tube.

15. A system comprising:
a tubing reel located at a surface;
a multi-layer coiled tube, the multi-layer coiled tube comprising an inner coiled tube; an outer tube circumferentially and longitudinally surrounding the inner coiled tube; and conductors positioned between the inner coiled tube and the outer tube, the conductors comprising electrical conductors and fiber optic cables;
wherein the multi-layer coiled tube is wrapped about the tubing reel at a first end of the multi-layer coiled tube, and wherein a second end of the multi-layer coiled tube, opposite the first end, is mechanically coupled with a tool, sensor, or combinations thereof within a wellbore;
wherein the electrical conductors are electrically coupled with the tool, sensor, or combinations thereof, and are electrically coupled with a control and monitoring system at the surface; and
wherein the fiber optic cables are optically coupled with the tool, sensor, or combinations thereof, and are optically coupled with the control and monitoring system at the surface.

16. The system of claim 15, wherein the outer tube and the inner coiled tube are both mechanically coupled with the tool, sensor, or combinations thereof.

17. A method comprising:
running a tool, sensor, or combinations thereof mechanically coupled with a multi-layer coiled tube down a wellbore from a location at the surface;
the multi-layer coiled tube comprising an inner coiled tube; an outer tube circumferentially and longitudinally surrounding the inner coiled tube; and conductors positioned between the inner coiled tube and the outer tube, the conductors comprising electrical conductors and fiber optic cables;
wherein the electrical conductors are electrically coupled with the tool, sensor, or combinations thereof, and are electrically coupled with a control and monitoring system at the surface; and
wherein the fiber optic cables are optically coupled with the tool, sensor, or combinations thereof, and are optically coupled with the control and monitoring system at the surface.

18. The method of claim 17, comprising pressurizing a central channel of the inner coiled tube while running the multi-layer coiled tube down the wellbore.

19. The method of claim 17, wherein the central channel of the inner coiled tube is pressurized to a predetermined pressure.

20. The method of claim 17, wherein the predetermined pressure ranges from 200 psi to 20,000 psi.
